(19) United States
(12) Patent Application Publication
(10) Pub. No.: US 2026/0219724 A1
(43) Pub. Date: Jul. 30, 2026

(54) INFORMATION PROCESSING APPARATUS AND CONTROL METHOD

(71) Applicant: Lenovo Japan LLC, Tokyo (JP)

(72) Inventors: Taiki Koide, Kanagawa (JP); Hiroki Oda, Kanagawa (JP)

(73) Assignee: Lenovo Japan LLC, Tokyo (JP)

(21) Appl. No.: 19/448,723

(22) Filed: Jan. 14, 2026

(30) Foreign Application Priority Data
Jan. 27, 2025 (JP) 2025-011208

(51) Int. Cl. G06F 1/3296; G06F 1/20

(52) U.S. Cl. CPC G06F 1/3296; G06F 1/206

(57) ABSTRACT

An information processing apparatus includes a host system configured to execute processing of an application program and is capable of determining one of N levels of power modes with different operating power as a power mode of the information processing apparatus depending on a program to be executed, the N being an integer greater than or equal to 2. The host system is configured to: refer to a list indicating at least an application program for each power mode, determine a power mode corresponding to an application program that runs in a foreground, and when a process of a priority application, is executed, prioritize a power mode for the priority application, the priority application is a predetermined specific application program,.

### CROSS-REFERENCE TO RELATED APPLICATIONS

This application claims priority to Japanese Patent Application No. 2025-011208 filed on January 27, 2025, the contents of which are hereby incorporated herein by reference in their entirety.

### Technical Field

The present application relates to an information processing apparatus and a control method, and relates to the control of power consumption required to execute an application program (they may be referred to as "application" or "app" in the present application), for example.

### Background

Information processing apparatuses, including personal computers (PCs), execute various applications to implement their functions. In general, the power consumption required for the execution varies greatly depending on the execution status of an application. Some information processing apparatuses are configured to control their operation modes depending on the execution status of an application.

For instance, the terminal control method described in PCT Japanese Translation Patent Publication No. 2018-515017 has a stage for detecting whether a condition for enabling a power saving mode is met when a screen of the terminal is switched from a screen-on state to a screen-off state, and a stage in which the condition for enabling a power saving mode is met, and for executing the power saving operation to reduce the power consumption that is generated during the execution of an application in the terminal in the background.

Information processing apparatuses that support a multitasking function enable the simultaneous execution of multiple applications. These information processing apparatuses may determine their operating mode depending on the type of the application running in the foreground. If the operating mode is determined uniformly depending on the type of the application running in the foreground, the apparatus may fail to obtain sufficient performance during the execution of other applications or may have trouble in the execution.

### SUMMARY

An information processing apparatus according to a first aspect of the present application includes a host system configured to execute processing of an application program and is capable of determining one of N levels of power modes with different operating power as a power mode of the information processing apparatus, depending on an application program to be executed, the N being an integer greater than or equal to 2. The host system is configured to refer to a list indicating at least an application program for each power mode, determine a power mode corresponding to an application program that runs in a foreground, and when a process of a priority application is executed, prioritize a power mode for the priority application. The priority application is a predetermined specific application program.

In the information processing apparatus, the power mode for the priority application may be a high-load mode with a highest operating power among the N levels of power modes.

In the information processing apparatus, when the power mode corresponding to an application program that runs in the foreground has the operating power that is lower than the high-load mode and the priority application runs in a background, the host system may determine the high-load mode as a power mode of the information processing apparatus.

In the information processing apparatus, the N is 3, the list indicates one or more types of application programs for each of a low-load modeand a high-load mode, the low-load mode being a power mode with a lowest operating power among the N levels of power modes, the high-load mode being a power mode with a highest operating power among the N levels of power modes, and when no application program that runs in the foreground is included in the list, the host system may determine a standard mode, as a power mode of the host system. The standard mode is a power mode with an intermediate operating power between the low-load mode and the high-load mode,

In the information processing apparatus, the host system is capable of selecting any one of M levels of power modes with different operating power as a power mode of the information processing apparatus in response to a user operation, the M being an integer greater than or equal to 2, a predetermined specific power mode among the M levels of power modes is common to a predetermined power mode among the N levels of power modes, and when the specific power mode is selected, the host system may determine one of the N levels of power modes as a power mode of the information processing apparatus, depending on an application program to be executed.

In the information processing apparatus, an index of the operating power may include thermal design power.

The information processing apparatus may further include a heat dissipation mechanism that dissipates heat generated in the information processing apparatus, wherein the information processing apparatus may determine an output of the heat dissipation mechanism so that the output increases with a power mode having higher operating power.

A control method according to a second aspect of the present application controls an information processing apparatus including a host system configured to execute processing of an application program and is capable of determining one of N levels of power modes with different operating power as a power mode of the information processing apparatus, depending on a application program to be executed, the N being an integer greater than or equal to 2, and the control method includes: referring to a list indicating at least an application program for each power mode, determining a power mode corresponding to an application program that runs in a foreground, and when a process of a priority application is executed, prioritize a power mode for the priority application, the priority application being a predetermined specific application program.

An information processing apparatus comprising a host system configured to execute processing of an application program and is capable of determining one of N+M-1 levels of power modes with different operating power as a power mode of the information processing apparatus depending on an application program to be executed, each of the N and the M being an integer greater than or equal to 2, wherein the host system is configured to: display, at a display, a configuration screen indicating the M levels of the power modes among the N+M-1 levels of the power modes; refer to a list indicating application programs configured for each of the N-1 levels of the power modes among the N+M-1 levels of the power modes when one specific level of a power mode is determined in response to a user operation among the M levels of the power modes; determine a power mode corresponding to an application program that runs in a foreground, among the N-1 levels of the power modes and the one specific level of the power mode, as a power mode of the information processing apparatus; when a process of a priority application is executed, prioritize a power mode for the priority application, the priority application being a predetermined specific application program; and determine the power mode as the power mode of the information processing apparatus when another power mode, different from the one specific level of the power mode, is determined in response to an user operation among the M levels of the power modes.

According to one or more embodiments of the present application, when a priority application is executed, expected performance can be maintained regardless of whether the application is executed in the background or foreground.

### BRIEF DESCRIPTION OF THE DRAWINGS

FIG. 1 is a schematic block diagram illustrating one example of the hardware configuration of an information processing apparatus according to one or more embodiments.

FIG. 2 is a schematic block diagram illustrating one example of the functional configuration of the information processing apparatus according to one or more embodiments.

FIG. 3 is a mode transition diagram illustrating the power modes according to one or more embodiments.

FIG. 4 illustrates an example of operating parameters set for each power mode.

FIG. 5 illustrates a whitelist according to one or more embodiments.

FIG. 6 illustrates the power mode setting screen.

FIG. 7 illustrates a display example of windows and icons according to one or more embodiments.

FIG. 8 illustrates a display example of a task manager screen according to one or more embodiments.

FIG. 9 is a flowchart illustrating a power mode control method according to one or more embodiments.

### DETAILED DESCRIPTION

The following describes embodiments of the present application, with reference to the drawings.

First, the following describes the overview of an information processing apparatus 1 according to one or more embodiments. The following mainly describes the information processing apparatus 1 by way of an example of a PC. The information processing apparatus 1 is not limited to a PC, which may be a smart phone, a tablet terminal, or similar apparatuses.

The information processing apparatus 1 includes a host system that executes various application programs. In this application, "executing a program" or “execution of a program" refers to the execution of processing directed by instructions written in the program (this also applies to an application). The host system has variable operating power. The host system operates in accordance with one of a plurality of power modes with different operating power levels. The host system has a list indicating applications for each power mode, and the list is set in advance. The host system operates in a multitasking environment and operates in an operating mode corresponding to the application running in the foreground. Note that the host system has a predetermined specific application that is set as a priority application. When the priority application is executed, the host system prioritizes the power mode that is applied to this priority application.

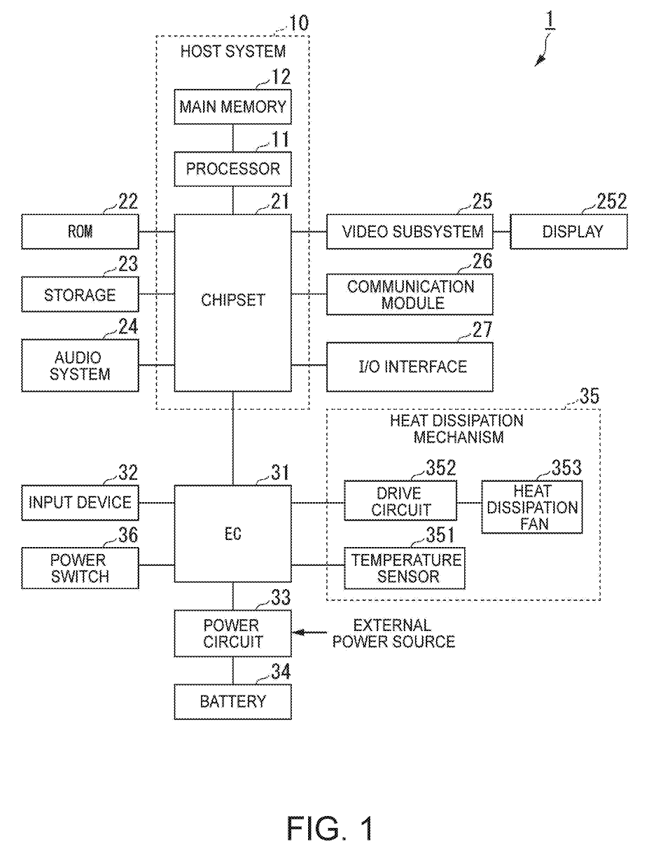

FIG. 1 is a schematic block diagram illustrating one example of the hardware configuration of the information processing apparatus 1 according to one or more embodiments. The information processing apparatus 1 includes a host system 10, a read only memory (ROM) 22, a storage 23, an audio system 24, a video subsystem 25, a display 252, a communication module 26, an input/output (I/O) interface 27, an embedded controller (EC) 31, an input device 32, a power circuit 33, a battery 34, a heat dissipation mechanism 35, and a power switch 36. The host system 10 is the core computer system of the information processing apparatus 1. The host system 10 includes a processor 11, a main memory 12, and a chipset 21. The processor 11 and the main memory 12 are the minimum hardware components that make up the host system 10. The heat dissipation mechanism 35 dissipates heat generated inside the information processing apparatus 1. The heat dissipation mechanism 35 includes a temperature sensor 351, a drive circuit 352 and a heat dissipation fan 353.

The processor 11 is a core processing unit that executes various arithmetic processes directed by instructions written in software (programs). The processes executed by the processor 11 include reading and writing data from and to storage media such as the main memory 12 and the storage 23, and inputting and outputting data to and from other devices. The processor 11 includes at least one central processing unit (CPU). The CPU controls the overall operation of the information processing apparatus 1. The CPU executes the processing of programs such as an operating system (OS), firmware, device drivers, utilities, and applications.

The main memory 12 is a writable memory functioning as a read-in area of a program executed by the processor 11 or a work area to write the data processed by the executed program. For instance, the main memory 12 includes a plurality of dynamic random access memory (DRAM) chips.

The chipset 21 includes a plurality of controllers and is connectable to a plurality of devices for input/output of various data. The controller is any one or a combination of bus controllers such as universal serial bus (USB), serial AT attachment (ATA), serial peripheral interface (SPI) bus, peripheral component interconnect (PCI) bus, PCI-Express bus, and low pin count (LPC). The devices to be connected include the ROM 22, the storage 23, the audio system 24, the video subsystem 25, the communication module 26, the input/output interface 27, and the EC 31.

The ROM 22 mainly stores system firmware, and firmware for controlling the operation of the EC 31 and other devices. The ROM 22 may be any of an electrically erasable programmable read only memory (EEPROM), a flash ROM, and others.

The storage 23 is an auxiliary storage device that stores various data used in the processing of the processor 11 and other devices, or various data acquired through such processing, and various programs. The storage 23 may be any one or a combination of a solid state drive (SSD), a hard disk drive (HDD) and similar devices.

The audio system 24, to which a microphone and a speaker not illustrated are connected, records, reproduces, and outputs audio data. The microphone and the speaker may be built in the information processing apparatus 1 or may be separate from the information processing apparatus 1.

The video subsystem 25 is to implement the functions related to image displaying, and includes a video controller. This video controller processes a drawing instruction from the processor 11 and writes the obtained drawing information on a video memory, and the video controller also reads this drawing information from the video memory and outputs the drawing information as display data indicating display information to the display 252 (image processing). The video subsystem 25 may be configured to include one or more graphic processing units (GPUs) or coprocessors. The GPU is a processor that mainly handles real-time image processing and other parallel arithmetic processes. The GPU may share some processing with the CPU. The GPU may be integrated with the CPU configured as the processor 11 and formed on the same core, or may be formed on a core separate from the CPU. The GPU may execute parallel arithmetic processing other than image processing, and may share some of the processing with the CPU.

The display 252 displays a display screen based on the display data input from the video subsystem 25. For instance, the display 252 may be any of a liquid crystal display (LCD), an organic light emitting diode (OLED) display, and others.

The communication module 26 connects to a communication network by wire or wirelessly. The communication module 26 communicates various data with other devices connected to the communication network. The communication module 26 includes a wireless local area network (LAN) which enables the devices to transmit and receive various types of data in accordance with a specific wireless communication standard (e.g., IEEE802.11). In a wireless LAN, communication between the devices is carried out via an access point.

The input/output interface 27 connects to various devices such as peripherals via wire or wirelessly. For instance, the input/output interface 27 includes a connector for wired data input/output according to USB regulations.

The EC 31 is a one-chip microcomputer to monitor and control various devices (e.g., peripherals and sensors), irrespective of the system state of the information processing apparatus 1. The EC 31 includes a CPU, a ROM, a RAM, and an analog-to-digital (A/D) input terminal, a digital-to-analog (D/A) output terminal, a timer, and a digital input/output terminal for a plurality of channels, which are not illustrated and separated from the processor 11. The input/output terminal of the EC 31 is connected, for example, to the input device 32, the power circuit 33, the temperature sensor 351, the drive circuit 352, and the power switch 36.

The input device 32 detects an operation by a user, and outputs an operation signal corresponding to the detected operation to the EC 31. For instance, the input device 32 may include any combination of a keyboard, a touchpad, and others. The input device 32 may be a touch sensor, which may overlap the display 252 and be configured as a touch panel.

The power circuit 33 converts the voltage of DC power supplied from an external power source or the battery 34 into a voltage required for the operation of each device that constitutes the information processing apparatus 1, and supplies the electricity having the converted voltage to the device. The power circuit 33 executes power supply under the control of the EC 31. The power circuit 33 includes a converter that converts the voltage of electricity supplied thereto, and a power feeder that charges the battery 34 with the electricity whose voltage has been converted. The power feeder charges the battery 34 with the power left unconsumed in each device from the power supplied by the external power source. If power is not supplied from the external power source, or if the power supplied from the external power source is insufficient, the power discharged from the battery 34 is supplied to each device as the operating power.

The battery 34 uses the power circuit 33 to charge or discharge electricity. For instance, the battery 34 may be any of a lithium-ion battery, a sodium-ion battery, and others.

The temperature sensor 351 detects its own temperature, and outputs a temperature signal indicating the detected temperature to the EC 31. The temperature sensor 351 may, for example, be installed in close proximity within a predetermined distance from the processor 11. In this case, the temperature of the processor 11 is detected for protection of the processor 11.

The drive circuit 352 supplies the power supplied thereto from the power circuit 33 to the heat dissipation fan 353 under the control of the EC 31. This controls the operation of the heat dissipation fan 353. The heat dissipation fan 353 dissipates heat generated in the information processing apparatus 1. The heat dissipation fan 353 includes a motor that consumes power supplied from the drive circuit 352 to rotate the fins, and causes air to flow into the chassis of the information processing apparatus 1. The air that has flowed in exchanges heat with each part of the information processing apparatus 1, and is then discharged to the outside of the chassis.

Each time the power switch 36 is pressed, it controls the state of electricity supply to the information processing apparatus 1 as a whole to either on (power ON) or off (power OFF). In response to the acceptance of the pressing operation, the power switch 36 outputs a pressing signal indicating the pressing to the EC 31. When the information processing apparatus 1 is powered off and a pressing signal is input from the power switch 36, the EC 31 causes the power circuit 33 to start supplying power to each device of the information processing apparatus 1 (power-on). When the processor 11 detects the start of power supply to itself, it reads system firmware from the ROM 22, loads it into the main memory 12, and executes a start-up process (boot) in accordance with the instructions written in the system firmware. In the start-up process, the processor 11 loads data that has been saved in the storage 23 into the main memory 12. Thereafter, the processor 11 starts the OS, and after the OS has finished starting up, the processor 11 starts executing device drivers related to the control of devices such as the storage 23, the communication module 26, the input/output interface 27, and others.

When power is supplied to the information processing apparatus 1 and a pressing signal is input from the power switch 36, the EC 31 causes the processor 11 to execute a stop process (shutdown). In the stop process, the processor 11 saves the data that exists in the work area at that time to the storage 23. After the saving of data has finished, the processor 11 stops the processing of the application, device driver, and other programs that are currently being executed. Thereafter, the processor 11 notifies the EC 31 of the completion of the stop processing. The EC 31 causes the power circuit 33 to stop supplying power to each device of the information processing apparatus 1.

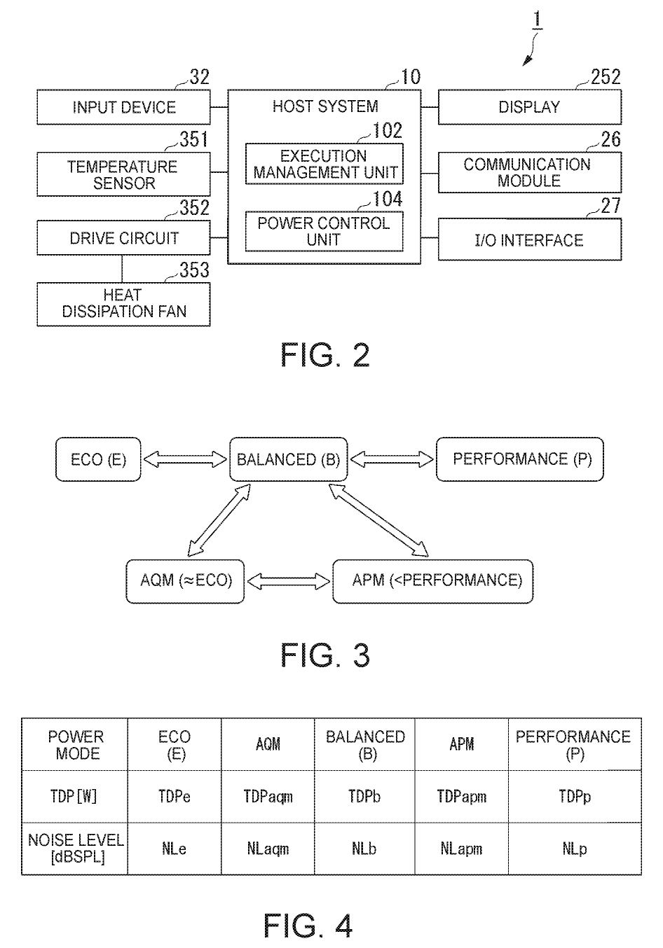

Next the following describes an example of the functional configuration of the information processing apparatus 1 according to one or more embodiments. FIG. 2 is a block diagram schematically illustrating one example of the functional configuration of the information processing apparatus 1 according to one or more embodiments.

The information processing apparatus 1 includes the host system 10.

In the host system 10, the processor 11 executes various programs and cooperates with hardware such as the main memory 12, the chipset 21, the communication module 26, the input/output interface 27, and the EC 31 to implement the functions.

The host system 10 is a computer system that executes the OS, manages the execution of other programs such as applications, manages memory, processes, and other computing resources, and manages the input/output with various devices. The host system 10 operates in accordance with the operating mode that it has determined. The host system 10 refers to a power control parameter set stored in advance in the register of the processor 11 and identifies the power control parameters related to the operation mode. The host system 10 controls power consumption using the identified power control parameters. The EC 31 also refers to the parameter set stored in advance in its own ROM to identify the drive parameters for the operation mode. The EC 31 causes the drive circuit 352 to drive the heat dissipation fan 353 using the identified drive parameters. Examples of the operation modes are described later.

The host system 10 includes an execution management unit 102 and a power control unit 104.

The execution management unit 102 enables the execution of one application or a plurality of applications simultaneously under a multitasking environment in accordance with the OS. The execution management unit 102 starts the execution of an application corresponding to an icon selected in response to an operation from among the icons displayed on the display 252, for example. After the start-up process of the host system 10 is completed, the execution management unit 102 may start the execution of a preset application (also called a "startup application").

When multiple applications are running, the execution management unit 102 determines one of the applications as a foreground process and the other applications as background processes.

The execution management unit 102 accommodates a display screen generated in accordance with the application being executed in the window and displays it on the display 252. The execution management unit 102 operates on the window (also called "foreground window" or "active window”) for the foreground process. That is, the execution management unit 102 accepts an operation signal indicating coordinates within the foreground window as input to the foreground process, and ignores an operation signal indicating coordinates within the other windows. In this application, operating or executing a process based on an input operation signal may be referred to as “performing... in response to an operation" or "in accordance with an operation."

The execution management unit 102 may display an array of icons indicating running applications on a taskbar assigned along the bottom of the display area of the display 252. For instance, the execution management unit 102 selects, as a foreground process, an application corresponding to an icon selected in response to an operation from among the displayed icons. The execution management unit 102 may also select, as a foreground process, the application related to the window having an area whose coordinates are instructed in response to the operation at that point in time (at the present time).

FIG. 7 illustrates an example of the windows and icons that are displayed when an application is executed. FIG. 7 illustrates three windows and three icons. The three windows occupy most of the display area of the display 252. These windows accommodate display screens that are displayed in response to execution of applications App1, App2, and App3, respectively. Icons of applications App1, App2, and App3 are arranged in this order along the bottom edge of the display area. In the example of FIG. 7, in response to pressing of the icon for application App1, its window is displayed in the foreground as the foreground window.

The execution management unit 102 manages operation state information indicating the operation status of each application currently being executed. The execution management unit 102 manages the status (Status), CPU usage rate (CPU), memory usage rate (Memory), disk usage rate (Disk), and network usage rate (Network) for each application. The status includes information indicating whether the running application is a foreground process or not. The execution management unit 102 may display, on the display 252, a screen that is a task manager screen (see FIG. 8) showing the operating status of each running application. Each time the operating state is changed, the execution management unit 102 may notify the power control unit 104 of the changed operating state information, or in response to an inquiry about the operating state from the power control unit 104, the execution management unit 102 may notify the power control unit 104 of the operating state information at that time.

The power control unit 104 controls the power mode based on an operation signal input from the input device 32 or an application currently being executed. FIG. 3 illustrates transition of the power modes according to one or more embodiments. In the example in FIG. 3, the host system 10 has five levels of power modes. The five power modes include eco mode (E), balanced mode (B), performance mode (P), auto quiet mode (AQM) and auto performance mode (APM). The host system 10 operates in accordance with one of the five power modes.

The power consumption parameters of the processor 11 (this may be called "power parameters" in this application) differ among the five power modes. The power consumption of the processor 11 increases in the order of the eco mode, the balanced mode, and the performance mode, and the power parameters of the processor 11 are set so that the power consumption in the eco mode is the lowest. The power parameters of the processor 11 in the AQM mode are less than the power parameters of the processor 11 in the balanced mode. The power parameters of the processor 11 in the APM mode are more than the power parameters of the processor 11 in the balanced mode.

When the power consumption of the processor 11 is large, the amount of heat generated also increases, thus increasing the need for heat dissipation. The EC 31 may have a setting such that the parameter for driving the heat dissipation mechanism 35 (this may be called "drive parameter" in this application) is larger for a power mode with a larger power parameter. In response to a change in the operation mode, the power control unit 104 notifies the EC 31 of the changed operation mode. The EC 31 may have the drive parameter set so that the output of the heat dissipation mechanism 35 corresponds to the notified operation mode, that is, the output is increased in the order of the eco mode, the balanced mode, and the performance mode. The driving parameter of the heat dissipation mechanism 35 in the AQM mode may be less than the driving parameter of the heat dissipation mechanism 35 in the balanced mode. The driving parameter of the heat dissipation mechanism 35 in the APM mode may be more than the driving parameter of the heat dissipation mechanism 35 in the balanced mode.

Next, the following describes an example of operating parameters for each power mode. In the example of FIG. 4, thermal design power (TDP) and maximum noise level are set for each power mode. TDP is the maximum heat dissipation amount that the processor 11 is designed to dissipate. That is, TDP is an index that indicates the steadily allowable power consumption and also an index that indicates the degree of heat generation. The power control unit 104, for example, monitors the power consumption of the processor 11 and controls the clock frequency so that the moving average of the power consumption within a predetermined period up to that time does not exceed the TDP. In general, the higher the clock frequency of the processor 11, the higher the power consumption.

The maximum noise level is the upper limit of the noise level caused by the operation of the heat dissipation fan 353. That is, the maximum noise level can be regarded as a driving parameter that indicates the allowable level of output of the heat dissipation fan 353. For the maximum noise level, for example, a noise level is set so as to relate to the output of the heat dissipation fan 353 when the amount of heat dissipation corresponding to TDP is generated. Instead of the maximum noise level, the rotation speed or power consumption of the heat dissipation fan 353 may be used as the drive parameter. The EC 31 causes the drive circuit 352 to drive the heat dissipation fan 353 so that the temperature notified from the temperature sensor 351 becomes equal to or higher than a predetermined operation start temperature and the noise does not exceed the drive parameter corresponding to the power mode notified from the power control unit 104.

In the example of FIG. 4, the TDPs for eco mode, AQM, balanced mode, APM, and performance mode are set as TDPe, TDPaqm, TDPb, TDPapm, and TDPp, respectively. TDPe, TDPb, and TDPp are set to increase in that order. The maximum noise levels for eco mode, AQM, balanced mode, APM and performance mode are set as NLe, NLaqm, NLb, NLApm and NLp, respectively. NLe, NLb, and NLp are set to increase in that order. Note that TDPe and NLe for the eco mode may be equal to TDPaqm and NLaqm for AQM, respectively. TDPapm and NLApm for APM may be equal to or smaller than TDPp and NLp for performance mode, respectively.

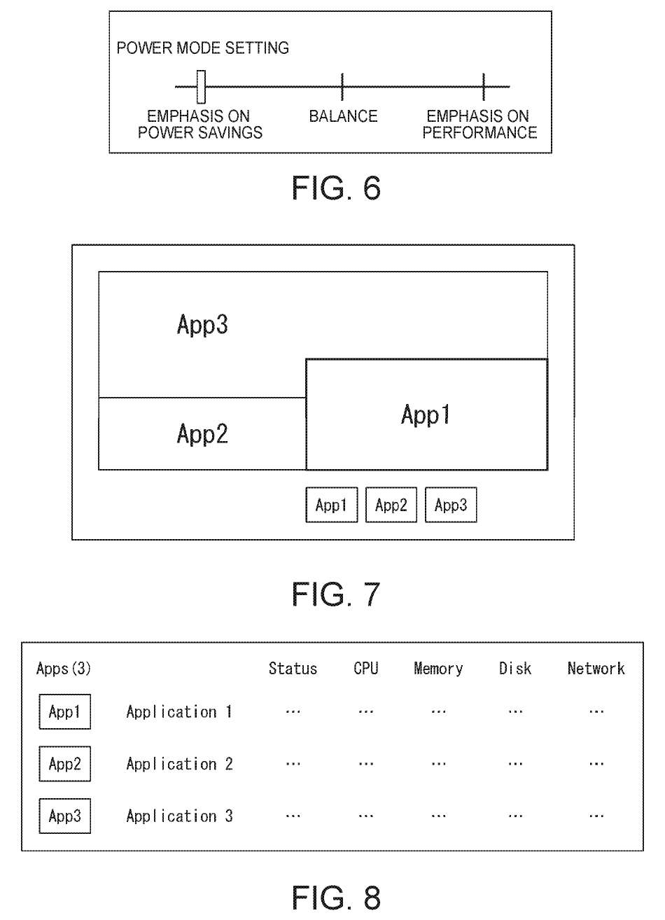

The power control unit 104 causes the display 252 to display a power mode setting screen. The power control unit 104 selects one of the power modes from the eco mode, the balanced mode, and the performance mode in accordance with an operation signal input from the input device 32. The power control unit 104 operates the processor 11 in the selected power mode. The power mode setting screen illustrated in FIG. 6 has a slider bar, thus enabling the position of a cursor designated by an operation signal to be set to any one of three scales on the slider bar. The power control unit 104 selects the power mode corresponding to the set scale. The terms "emphasis on power savings," "balance," and "emphasis on performance," which are written alongside the scales, indicate eco-mode, balanced mode, and performance mode, respectively. That is, FIG. 6 illustrates the case in which the eco mode is selected.

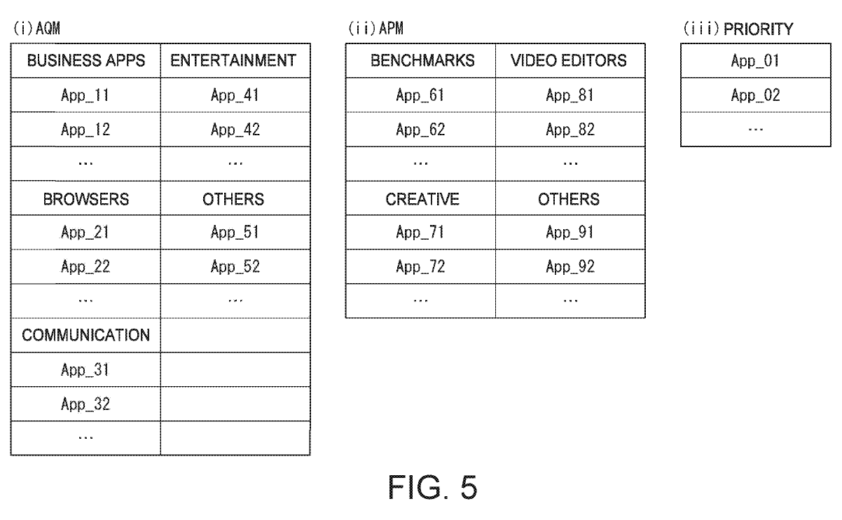

The power control unit 104 has a list (whitelist) indicating application names for each power mode, and the list is created and stored in advance. No whitelist may be set for a given power mode, and a whitelist may be set for other power modes. In the example of FIG. 5(i), App_11, App_12,..., App_52,... are written in the whitelist related to AQM. These applications, such as business applications and browsers, consume relatively little power for their processing. In the example of FIG. 5(ii), App_61, App_62,..., App_92,... are written in the whitelist related to APM. These applications, such as benchmarks and creative applications, consume relatively large amounts of power for their processing.

Thus, the power control unit 104 determines whether the name of the application (also called "application name”) that is currently the foreground process is included in the whitelist. The power control unit 104 refers to the operating state information notified by the execution management section 102, and thus is able to identify the application name of the running application. If a whitelist containing the application name exists, the power control unit 104 selects the power mode corresponding to that whitelist. If a whitelist containing the application name exists, the power control unit 104 selects the power mode (e.g., any of AQM and APM) corresponding to that whitelist. If no whitelist containing the application name exists, the power control unit 104 may select a predetermined power mode (e.g., balanced mode).

In one or more embodiments, the power control unit 104 may designate a specific application as a priority application and set the power mode for the priority application in advance. The power control unit 104 may have a priority application list indicating priority applications, which is separate from the whitelist for each power mode. The priority application list illustrated in FIG. 5(iii) includes App_01, App_02,... For a running priority application, the power control unit 104 selects a power mode for the priority application regardless of whether the priority application is a foreground process or not. That is, the power mode for a priority application is applied in preference to other running applications. For a priority application, APM may be set for applications that routinely consume large amounts of power during their execution, for example. The power control unit 104 executes such a priority application with the power mode set to APM, and therefore enables exertion of the performance. Priority applications include applications that routinely involve large amounts of computation, such as video generation using generative AI and AI model inference. If there are multiple priority applications running, the power control unit 104 may select the largest power mode among the power modes for those multiple priority applications.

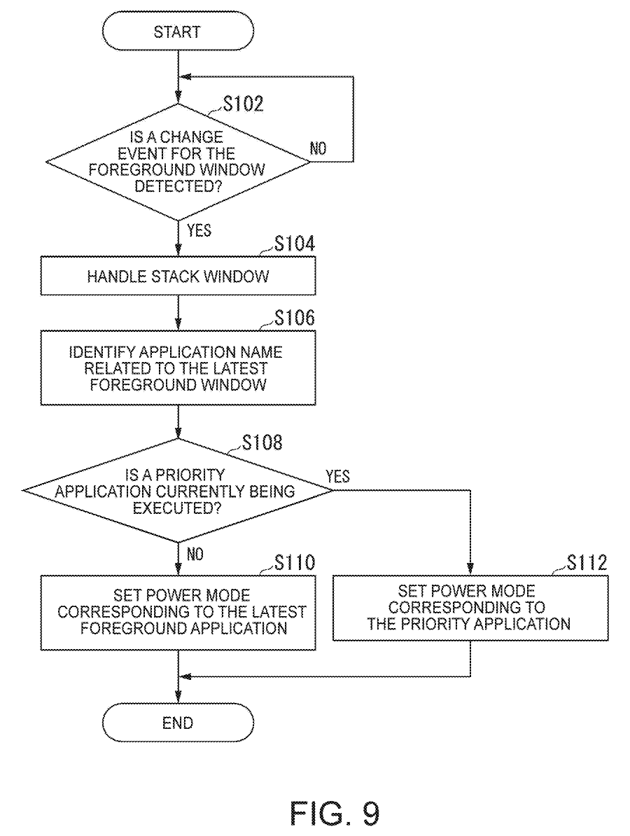

Next, the following describes an example of a power mode control method according to one or more embodiments. FIG. 9 is a flowchart illustrating a power mode control method according to one or more embodiments. The following describes an example where the power mode of the host system 10 is set to the balanced mode in accordance with an operation, and is variable between other modes including the balanced mode, APM, and AQM.

(Step S102) The execution management unit 102 monitors a change event for the foreground window. The change event for the foreground window refers to an operation that changes the foreground process. For instance, this includes pressing the icon in the running application and operating the window of the running application. When a change event for the foreground window is detected (Step S102 YES), the process proceeds to step S104. When no change event of the foreground window is detected (step S102 NO), the processing of step S102 is repeated.

(Step S104) The execution management 102 executes the process of stack window handle to display the window related to a new foreground process as a foreground window on the foremost screen of the display 252. The execution management unit 102 starts accepting operations within the display area of the window as input to the new foreground process. The execution management unit 102 displays the original foreground window as a background window behind the foreground window, and stops accepting operations within the display area of that window.

(Step S106) The power control unit 104 refers to the operation state information notified by the execution management unit 102 to identify the application name (binary name) of the application related to the latest foreground window.

(Step S108) The power control unit 104 determines whether a priority application is currently being executed. When it is determined that a priority application is currently executed (step S108 YES), the process proceeds to step S112. When it is determined that no priority application is executed (step S108 NO), the process proceeds to step S110.

(Step S110) The power control unit 104 refers to the whitelist, identifies the power mode corresponding to the latest foreground application, and sets the identified power mode to the processor 11.

(Step S112) The power control unit 104 identifies the power mode (e.g., AQM) corresponding to the latest foreground application, and sets the identified power mode to the processor 11. After that, the process of FIG. 9 ends.

As described above, the information processing apparatus 1 according to one or more embodiments includes the host system 10 that executes the processing of an application program and is able to determine one of N (N is an integer greater than or equal to 2) levels of power modes (e.g., APM, balanced mode, and AQM) with different operating power (i.e., power consumption) as the power mode of the apparatus, depending on the program to be executed. The host system 10 refers to a list (e.g., whitelist) indicating application programs for each power mode, determines the power mode corresponding to an application program that runs in the foreground, and when a process of a priority application, which is a predetermined specific application program, is executed, prioritizes a power mode for the priority application.

With this configuration, when a priority application is executed, the host system 10 operates in accordance with the power mode for the priority application, regardless of whether the application is running in the foreground. Thus, the information processing apparatus 1 exerts the performance required to execute the priority application.

The power mode for the priority application may be the high-load mode with the highest operating power among the N levels of power modes.

Note that when the power mode corresponding to the application program that runs in the foreground has lower operating power than the high-load mode, and a priority application runs in the background, the host system 10 may determine the high-load mode as its power mode.

With this configuration, the host system 10 operates in the high-load mode regardless of the power mode corresponding to other running applications. Therefore, even when another application is executed in the foreground, the apparatus is able to exert the performance related to the processing for the priority application.

When N is 3, the list indicating applications indicates one or more types of application programs for each of a low-load mode (e.g., AQM), which is the power mode with the lowest operating power among the N levels of power modes, and a high-load mode (e.g., APM), which is the power mode with the highest operating power among the N levels of power modes, and no application program that runs in the foreground exists, the host system 10 may determine a standard mode (e.g., balanced mode), which is a power mode with an intermediate operating power between the low-load mode and the high-load mode, as the power mode for the system.

N is not limited to 3, but may be 2 or 4 or more. AQM may be a power mode with power parameters equivalent to eco mode. APM may be a power mode with power parameters equivalent to performance mode.

The host system may select any one of M levels of power modes (M is an integer greater than or equal to 2) with different operating power (e.g., eco mode, balanced mode, performance mode) as its own power mode in response to a user operation. A predetermined specific power mode (e.g., balanced mode) among the M levels of power modes is common to a predetermined power mode among the N levels of power modes, and when the specific power mode is selected, the host system may determine one of the N levels of power modes as its power mode depending on the application program being executed.

With this configuration, one of the M levels of power modes is selected in response to a user operation. When the power mode selected in response to a user operation is the predetermined specific power mode, one of the N levels of power modes is selected in response to the application program to be executed.

M is not limited to 3, but may be 2 or 4 or more.

The index for operating power may include thermal design power.

The apparatus may include the heat dissipation mechanism 35 for dissipating heat generated therein, and may determine the output of the heat dissipation mechanism 35 so that the output increases with the operating power of a power mode.

With this configuration, the amount of heat generated increases as the operating power of the power mode increases, so the amount of heat dissipation can be increased by increasing the output of the heat dissipation mechanism 35. This mitigates deterioration due to heat generation.

That is detailed descriptions on the embodiments of the present invention with reference to the drawings. The specific configuration of the present invention is not limited to the above-described embodiments, and also includes design modifications or the like within the scope of the present invention. The configurations described in the above embodiments can be combined as needed unless such a combination is inconsistent with present invention, and some of the configurations may be omitted.

For instance, the heat dissipation mechanism 35 may be omitted in the information processing apparatus 1. In this case, the process for setting the drive parameter for the heat dissipation mechanism 35 is omitted. The information processing apparatus 1 may include a refrigerant circulation circuit instead of or together with the drive circuit 352 and the heat dissipation fan 353. In this case, instead of or together with the operating amount of the heat dissipation fan 353, the circulation amount of the refrigerant circulation circuit may be controlled in a similar relationship to the power consumption of the host system 10 and the operating amount of the heat dissipation fan 353.

### Description of Symbols

1 information processing apparatus

11 processor

12 main memory

21 chipset

22 ROM

23 storage

24 audio system

25 video subsystem

26 communication module

27 input/output interface

31 EC

32 input device

33 power circuit

34 battery

35 heat dissipation mechanism

36 power switch

252 display

351 temperature sensor

352 drive circuit

353 heat dissipation fan

What is claimed is:

1. An information processing apparatus comprising a host system configured to execute processing of an application program and is capable of determining one of N levels of power modes with different operating power as a power mode of the information processing apparatus depending on an application program to be executed, the N being an integer greater than or equal to 2, wherein
the host system is configured to:
refer to a list indicating at least an application program for each power mode;
determine a power mode corresponding to an application program that runs in a foreground; and
when a process of a priority application is executed, prioritize a power mode for the priority application, the priority application being a predetermined specific application program.

2. The information processing apparatus according to claim 1, wherein the power mode for the priority application is a high-load mode with a highest operating power among the N levels of power modes.

3. The information processing apparatus according to claim 2, wherein,
when the power mode corresponding to an application program that runs in the foreground has the operating power that is lower than the high-load mode and the priority application runs in a background, the host system determines the high-load mode as a power mode of the information processing apparatus.

4. The information processing apparatus according to claim 2, wherein
the N is 3,
the list indicates one or more types of application programs for each of a low-load mode and a high-load mode, the low-load mode being a power mode with a lowest operating power among the N levels of power modes, the high-load mode being a power mode with a highest operating power among the N levels of power modes, and
when no application program that runs in the foreground is included in the list, the host system determines a standard mode as a power mode of the host system, the standard mode being a power mode with an intermediate operating power between the low-load mode and the high-load mode.

5. The information processing apparatus according to claim 2, wherein the host system is capable of selecting any one of M levels of power modes with different operating power as a power mode of the information processing apparatus in response to a user operation, the M being an integer greater than or equal to 2,
a predetermined specific power mode among the M levels of power modes is common to a predetermined power mode among the N levels of power modes, and
when the specific power mode is selected, the host system determines one of the N levels of power modes as a power mode of the information processing apparatus depending on an application program to be executed.

6. The information processing apparatus according to claim 1, wherein an index of the operating power includes thermal design power.

7. The information processing apparatus according to claim 1, further comprising a heat dissipation mechanism that dissipates heat generated in the information processing apparatus, wherein
the information processing apparatus determines an output of the heat dissipation mechanism so that the output increases with a power mode having higher operating power.

8. A control method of an information processing apparatus that includes a host system configured to execute processing of an application program and is capable of determining one of N levels of power modes with different operating power as a power mode of the information processing apparatus depending on an application program to be executed, the N being an integer greater than or equal to 2,
the control method comprising:
referring to a list indicating at least an application program for each power mode;
determining a power mode corresponding to an application program that runs in a foreground; and
when a process of a priority application is executed, prioritizing a power mode for the priority application, the priority application being a predetermined specific application program.

9. An information processing apparatus comprising a host system configured to execute processing of an application program and is capable of determining one of N+M-1 levels of power modes with different operating power as a power mode of the information processing apparatus depending on an application program to be executed, each of the N and the M being an integer greater than or equal to 2, wherein
the host system is configured to:
display, at a display, a configuration screen indicating the M levels of the power modes among the N+M-1 levels of the power modes;
refer to a list indicating application programs configured for each of the N-1 levels of the power modes among the N+M-1 levels of the power modes when one specific level of a power mode is determined in response to a user operation among the M levels of the power modes;
determine a power mode corresponding to an application program that runs in a foreground, among the N-1 levels of the power modes and the one specific level of the power mode, as a power mode of the information processing apparatus;
when a process of a priority application is executed, prioritize a power mode for the priority application, the priority application being a predetermined specific application program; and
determine the power mode as the power mode of the information processing apparatus when another power mode, different from the one specific level of the power mode, is determined in response to an user operation among the M levels of the power modes.
